(19) United States
(12) Patent Application Publication
(10) Pub. No.: US 2026/0371007 A1
(43) Pub. Date: Nov. 19, 2026

(54) AUDIO EXTENSION SYSTEM, LOW ENERGY AUDIO EXTENSION DEVICE AND SYSTEM

(71) Applicant: SAMSUNG ELECTRONICS CO., LTD., Suwon-si (KR)

(72) Inventors: Xin PAN, Xi'An (CN); Hongli Ge, Xi'An (CN); Qianchuang Li, Xi'An (CN)

(73) Assignee: SAMSUNG ELECTRONICS CO., LTD., Suwon-si (KR)

(21) Appl. No.: 19/233,732

(22) Filed: Jun. 10, 2025

(30) Foreign Application Priority Data
May 13, 2025 (CN) 202510614579.9

(51) Int. Cl. H04R 3/00; H04W 4/80

(52) U.S. Cl. CPC H04R 3/00; H04W 4/80; H04R 2420/01; H04R 2420/05; H04R 2420/07

(57) ABSTRACT

An audio extension system, method, and device, including: an audio source device configured to, based on detecting an audio extension device, transmit connection information associated with an audio receiving device to the audio extension device, wherein the audio source device is configured to support a Bluetooth Classic protocol; the audio extension device, wherein the audio extension device is configured to establish a Bluetooth Low Energy (BLE) connection according to a BLE protocol between the audio extension device and the audio receiving device based on the connection information, and transmit audio data received from the audio source device to the audio receiving device using the BLE connection; and the audio receiving device, wherein the audio receiving device is configured to play audio associated with the audio data.

### CROSS-REFERENCE TO RELATED APPLICATIONS

This application is based on and claims priority under 35 U.S.C. § 119 to Chinese Patent Application No. 202510614579.9, filed on May 13, 2025, in the China National Intellectual Property Administration, the disclosure of which is incorporated by reference herein in its entirety.

### BACKGROUND

### 1. Field

The present disclosure relates to a Bluetooth audio, and more specifically, relates to an audio extension system and a Bluetooth Low Energy (BLE) audio extension device and system.

### 2. Description of Related Art

Bluetooth may refer to a short-range wireless communication standard that may include a Bluetooth Classic protocols and a Bluetooth Low Energy (BLE) protocols, as described for example in the Bluetooth Core Specification version 4.0 and subsequent versions. The BLE protocols may provide characteristics of higher-quality audio transmission and lower-energy in comparison with the Bluetooth Classic protocols. To support BLE audio for audio devices, a different hardware structure may be used. However, if users wish to listen to BLE audio, both audio source devices (e.g., mobile phones, computers) and audio receiving devices (e.g., earphones, speakers, etc.) may be required to support BLE audio simultaneously.

Many Bluetooth audio source devices may not yet support the BLE protocols. Therefore, if users only have audio receiving devices that support BLE audio, they may be unable to stream BLE audio. It may be relatively costly to update audio source devices to support BLE audio.

### SUMMARY

Provided is an audio extension system, and a Bluetooth Low Energy (BLE) audio extension device and system.

Additional aspects will be set forth in part in the description which follows and, in part, will be apparent from the description, or may be learned by practice of the presented embodiments.

In accordance with an aspect of the disclosure, an audio extension method includes: based on an audio extension device being detected by an audio source device, receiving, by the audio extension device, connection information associated with an audio receiving device from the audio source device, wherein the audio source device is configured to support a Bluetooth Classic protocol; establishing, by the audio extension device, a Bluetooth Low Energy (BLE) connection according to a BLE protocol between the audio extension device and the audio receiving device according to the connection information; and transmitting, by the audio extension device, audio data received from the audio source device to the audio receiving device using the BLE connection, wherein audio corresponding to the audio data is played by the audio receiving device.

In accordance with an aspect of the disclosure, an audio extension system includes: an audio source device configured to, based on detecting an audio extension device, transmit connection information associated with an audio receiving device to the audio extension device, wherein the audio source device is configured to support a Bluetooth Classic protocol; the audio extension device, wherein the audio extension device is configured to establish a Bluetooth Low Energy (BLE) connection according to a BLE protocol between the audio extension device and the audio receiving device based on the connection information, and transmit audio data received from the audio source device to the audio receiving device using the BLE connection; and the audio receiving device, wherein the audio receiving device is configured to play audio associated with the audio data.

In accordance with an aspect of the disclosure, an audio extension device includes: at least one processor; at least one memory configured to store computer executable instructions, wherein the computer executable instructions, when executed by the at least one processor, cause the audio extension device to: receive, from an audio source device, connection information associated with an audio receiving device based on the audio source device detecting the audio extension device, wherein the audio source device is configured to support a Bluetooth Classic protocol; establishing a Bluetooth Low Energy (BLE) connection according to a BLE protocol between the audio extension device and the audio receiving device based on the connection information; and transmitting, by the audio extension device, audio data received from the audio source device to the audio receiving device using the BLE connection, wherein the audio receiving device is configured to play audio corresponding to the audio data.

### BRIEF DESCRIPTION OF DRAWINGS

e above and other aspects, features, and advantages of certain embodiments of the present disclosure will be more apparent from the following description taken in conjunction with the accompanying drawings, in which:

FIG. 1 shows a flowchart of an audio extension method according to an exemplary embodiment of the present disclosure.

FIG. 2 shows a schematic diagram of classic Bluetooth connection.

FIG. 3 shows a schematic diagram of an audio extension method according to an exemplary embodiment of the present disclosure.

FIG. 4 shows a flowchart of a method of transmitting a BLE audio from a BLE audio extension device to a Bluetooth audio receiving device through BLE connection according to an exemplary embodiment of the present disclosure.

FIG. 5 shows a schematic diagram of switching a Bluetooth audio playing channel to a broadcast channel of a BLE audio extension device.

FIG. 6 shows a flowchart of a method of transmitting a BLE audio from a BLE audio extension device to a Bluetooth audio receiving device through BLE connection according to an exemplary embodiment of the present disclosure.

FIG. 7 shows a schematic diagram of scanning and synchronizing other external broadcast sources according to an exemplary embodiment of the present disclosure.

FIG. 8 shows a flowchart of a method of transmitting a BLE audio from a BLE audio extension device to a Bluetooth audio receiving device through BLE connection according to an exemplary embodiment of the present disclosure.

FIG. 9 shows a schematic diagram of switching a Bluetooth audio playing channel to a unicast channel of a BLE audio extension device.

FIG. 10 shows a flowchart of an audio extension method according to an exemplary embodiment of the present disclosure.

FIGS. 11 and 12 show schematic diagrams of removing a BLE audio extension device.

FIG. 13 shows a flowchart of broadcast extension according to an exemplary embodiment of the present disclosure.

FIG. 14 shows a flowchart of scanning and synchronizing other external broadcast sources according to an exemplary embodiment of the present disclosure.

FIG. 15 shows a flowchart of unicast extension according to an exemplary embodiment of the present disclosure.

FIG. 16 shows a schematic diagram of an audio extension system according to an exemplary embodiment of the present disclosure.

### DETAILED DESCRIPTION OF EMBODIMENTS

The following detailed description is provided to facilitate an understanding of methods, apparatuses, and/or systems described herein. However, various changes, modifications, and equivalents of methods, apparatuses, and/or systems described herein will be apparent from the description, or may be learned by practice of embodiments of the disclosure. For example, the sequences of operations described herein are merely examples, and are not limited to those set forth herein, but may be changed as will be apparent from the description in addition to the operations that must occur in a specific sequence. Also, the descriptions of features that are known in the art may be omitted for increased clarity or conciseness.

The features described herein may be embodied in different forms and are not intended to be limited to the specific examples described herein. Rather, the examples described herein have been provided merely to illustrate some of the many possible ways of implementing methods, apparatuses, and/or systems described herein that will be apparent from the description.

As used herein, the term “and/or” includes any one of, and any combination of any two or more of, the associated items.

Although terms such as “first,” “second,” and “third” may be used herein to describe various members, components, regions, layers, or sections, these members, components, regions, layers, or sections are not intended to be limited by these terms. Rather, these terms are only used to distinguish one member, component, region, layer, or section from another member, component, region, layer, or section. Thus, a first member, component, region, layer, or section referred to in an example described herein may also be referred to as a second member, component, region, layer, or section in another example.

Throughout the disclosure, when a first element (such as a layer, region, or substrate) is described as being “on” another element, “connected to” or “coupled to” a second element, the first element may be disposed directly “on” the second element, directly “connected to” or “coupled to” the second element, or there may be one or more other elements disposed between the first element and the second element. However, when the first element is described as being “directly on” the second element, “directly connected to” or “directly coupled to” the second element, there may be no other components disposed between the first element and the second element.

According to embodiments, when an action or operation is referred to as occurring “in response to” an event or occurrence, this may mean that action or operation occurs directly or indirectly in response to or based on the event or occurrence.

The terms used herein are only for describing various examples and will not be used to restrict the disclosure. Unless the context clearly indicates otherwise, singular forms are also intended to include plural forms. The terms “including”, “including”, and “having” indicate the presence of stated features, numbers, operations, members, elements, and/or combinations thereof, but do not exclude the presence or addition of one or more other features, numbers, operations, members, elements, and/or their combinations thereof.

Unless otherwise defined, all terms used herein (including technical and scientific terms) may have the same meaning as those commonly understood by the ordinary person in the field to which this disclosure belongs after understanding the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

In addition, in the description, when it is deemed that a detailed description of a well-known relevant structure or function will lead to a vague interpretation of the present disclosure, such detailed description may be omitted.

Hereinafter, embodiments are described in detail with reference to the accompanying drawings. The same reference numerals may be used for the same components in the drawings, and redundant descriptions thereof may be omitted. However, embodiments may be implemented in various forms and are not limited to the specific examples described herein.

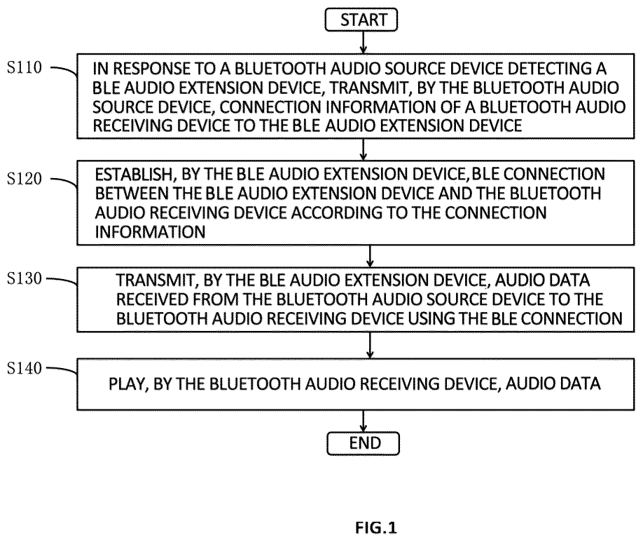

FIG. 1 shows a flowchart of an audio extension method according to an exemplary embodiment of the present disclosure.

Referring to FIG. 1, in operation S110, in response to a Bluetooth audio source device 101 detecting a Bluetooth Low Energy (BLE) audio extension device 103, connection information of a Bluetooth audio receiving device 102 is transmitted to the BLE audio extension device 103 by the Bluetooth audio source device 101. In embodiments, the Bluetooth audio source device 101 may be configured to support Bluetooth Classic protocols, which may be referred to as Bluetooth Classic. In embodiments, the BLE audio extension device 103 and the Bluetooth audio receiving device may be configured to support one or more BLE protocols, which may be referred to as BLE, and Bluetooth Classic protocols. In embodiments, Bluetooth Classic and BLE may correspond to the Bluetooth Core Specification version 4.0 and subsequent versions, but embodiments are not limited thereto. According to embodiments, the Bluetooth audio source device 101 may be referred to as an audio source device, the Bluetooth audio receiving device 102 may be referred to as an audio receiving device, and the BLE audio extension device 103 may be referred to as a BLE audio extension device and/or an audio extension device, but embodiments are not limited thereto.

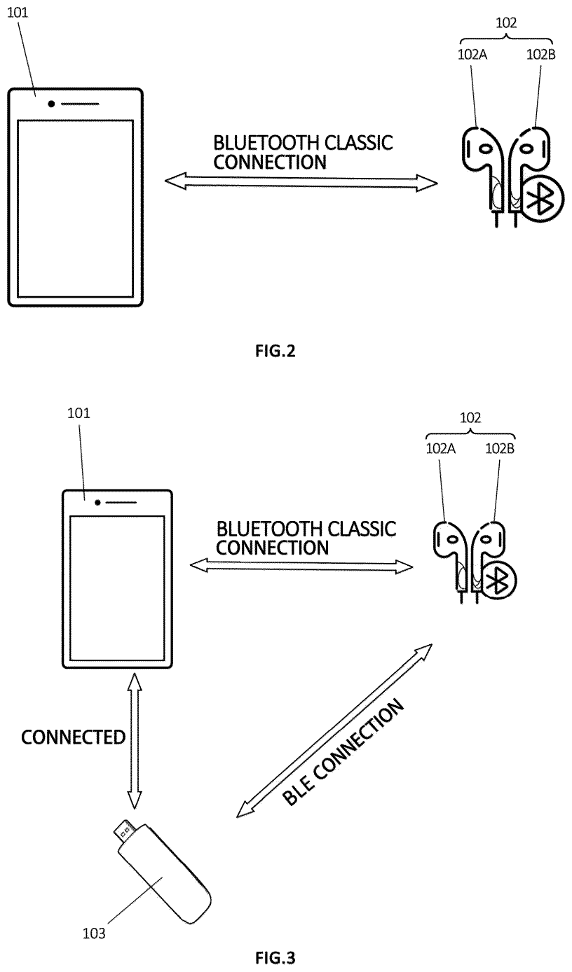

In one example, with reference to FIG. 2, a Bluetooth audio source device 101 may be connected through Bluetooth Classic to a Bluetooth audio receiving device 102. Accordingly, the Bluetooth audio receiving device 102 may receive audio data from the Bluetooth audio source device 101 through the Bluetooth Classic. For example, the Bluetooth audio source device 101 may be configured to support a Bluetooth Classic connection with the Bluetooth audio source device 101. In some embodiments, a Bluetooth audio source device 101 and a Bluetooth audio receiving device 102 may be connected through Bluetooth Classic and the Bluetooth audio source device 101 is playing an audio, and the Bluetooth audio receiving device 102 receives audio data through the Bluetooth Classic. Although FIG. 2 illustrates an example in which the Bluetooth audio source device 101 is shown as a mobile device and the Bluetooth audio receiving device 102 is shown as a pair of Bluetooth earphones including a first Bluetooth earphone 102A and a second Bluetooth earphone 102B, the present disclosure is not limited thereto. For example, a Bluetooth audio source device 101 may be any device that supports Bluetooth Classic (e.g., only as an example, a computer, etc.), and a Bluetooth audio receiving device 102 may be any device that supports Bluetooth Classic (e.g., only as an example, a speaker, etc.).

The Bluetooth audio source device 101 may detect BLE audio expansion devices in various ways. In one example, a Bluetooth audio source device 101 detects a BLE audio extension device 103 when the BLE audio extension device 103 is connected (e.g., externally) to the Bluetooth audio source device 101. In another example, a Bluetooth audio source device 101 may detect a BLE audio extension device 103 when the BLE audio extension device 103 is connected (e.g., wirelessly connected) to the Bluetooth audio source device 101 through predetermined communication.

Connection information of the Bluetooth audio receiving device 102 may be information (e.g., at least one parameter) required or used to establish communication connection (e.g., BLE connection) between the BLE audio extension device 103 and the Bluetooth audio receiving device 102, wherein the at least one parameter may include a device address and a device name. In one example, the connection information of the Bluetooth audio receiving device 102 may include a device address and a device name of the Bluetooth audio receiving device 102.

In one embodiment, if the Bluetooth audio source device 101 detects a BLE audio extension device 103 and the Bluetooth audio source device 101 is playing an audio, the Bluetooth audio source device 101 transmits the connection information of the Bluetooth audio receiving device 102 to the BLE audio extension device 103 through an external device management module.

At operation S120, the BLE connection between the BLE audio extension device 103 and the Bluetooth audio receiving device 102 may be established by the BLE audio extension device 103 according to the connection information.

For example, with reference to FIG. 3, the Bluetooth audio source device 101 may be configured to support the Bluetooth Classic with the Bluetooth audio source device 101. As shown in FIG. 3, the BLE connection between the BLE audio extension device 103 and the Bluetooth audio receiving device 102 may be performed by the BLE audio extension device 103 according to the connection information, when the BLE audio extension device 103 is connected to the Bluetooth audio source device 101. Thus, the audio expansion method according to an exemplary embodiment of the present disclosure may transmit (e.g., preconfigure) the connection information (e.g., the parameters required by a BLE audio (such as an address of the audio receiving device) to the BLE audio expansion device by using the connection between the Bluetooth audio source device 101 and the BLE audio extension device 103), so that the BLE audio extension device 103 may perform BLE connection between the BLE audio extension device 103 and the Bluetooth audio receiving device 102 according to the connection information, thereby reducing the complexity of the connection process for the user, and realizing plug-and-play function of the BLE audio function.

In one embodiment, a BLE audio extension device 103 automatically scans and automatically connects a Bluetooth audio receiving device 102 according to the connection information transmitted by the Bluetooth audio source device 101, and this process may be performed without input by a user.

In addition, the BLE audio extension device 103 scans connectable extended broadcast according to the connection information transmitted by the Bluetooth audio source device 101, and initiates BLE connection after identifying the Bluetooth audio receiving device 102 to be connected. In a Bluetooth pairing stage, the Bluetooth audio receiving device 102 and the external BLE audio device have configured prior information such as the device address, the device name, etc. through the Bluetooth audio source device 101. In the pairing stage, a pairing process is completed directly without user intervention.

In some embodiments, the Bluetooth Classic connection between the Bluetooth audio source device 101 and the Bluetooth audio receiving device 102 is disconnected after performing the BLE connection between the BLE audio extension device 103 and the Bluetooth audio receiving device 102.

At operation S130, a BLE audio, which may also be referred to as audio data or BLE audio data, received from the Bluetooth audio source device 101 is transmitted to the Bluetooth audio receiving device 102 by the BLE audio extension device 103 via the BLE connection.

For example, the BLE audio extension device 103 may receive the BLE audio from the Bluetooth audio source device 101 through the connection between the BLE audio extension device 103 and the Bluetooth audio source device 101, and transmit the received BLE audio to the Bluetooth audio receiving device 102 through the BLE connection between the BLE audio extension device 103 and the Bluetooth audio receiving device 102. The BLE audio can be any type of audio that the Bluetooth audio source device 101 is capable of sending to the outside (e.g., the BLE audio extension device 103). The any type of audio that the Bluetooth audio source device 101 is capable of sending to the outside (e.g., the BLE audio extension device 103) can be referred to here as the BLE audio because the any type of audio that the Bluetooth audio source device 101 is capable of sending to the outside (e.g., the BLE audio extension device 103) will be sent to the Bluetooth audio receiving device 102 via the BLE connection, either as-is or with appropriate modifications. In other words, the term “BLE audio” can be used interchangeably with the term “audio”.

At operation S140, the BLE audio (e.g., audio corresponding to BLE audio data) is played by the Bluetooth audio receiving device 102.

For example, the user may listen to the BLE audio by playing the BLE audio via the Bluetooth audio receiving device 102. Thus, the audio extension method according to the exemplary embodiment of the present disclosure may implement a function of extending a Bluetooth Classic audio to the BLE audio using the BLE audio extension device 103 without changing hardware of the original Bluetooth audio source device 101 and Bluetooth audio receiving device 102.

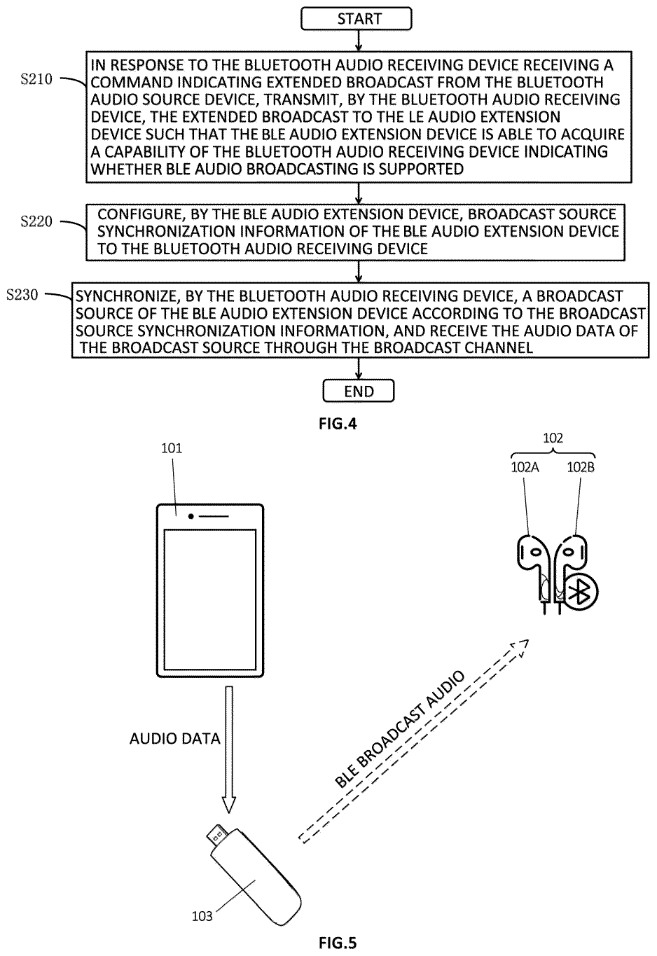

FIG. 4 shows a flowchart of a method of transmitting a BLE audio from a BLE audio extension device 103 to a Bluetooth audio receiving device 102 through BLE connection according to an exemplary embodiment of the present disclosure.

In the exemplary embodiment of FIG. 4, the BLE audio may include audio data of a broadcast source, and the BLE connection may include connection indicating a broadcast channel from the BLE audio extension device 103 to the Bluetooth audio receiving device 102.

Referring to FIG. 4, at operation S210, in response to the Bluetooth audio receiving device 102 receiving a command indicating extended broadcast from the Bluetooth audio source device 101, an extended broadcast is transmitted to the BLE audio extension device 103 by the Bluetooth audio receiving device 102 such that the BLE audio extension device 103 is able to acquire a capability (e.g., obtain information about a capability) of the Bluetooth audio receiving device 102 indicating whether BLE audio broadcasting is supported.

The Bluetooth audio receiving device 102 may transmit the extended broadcast, so that the BLE audio extension device 103 may scan and connect the extended broadcast. In one example, an enable extended broadcast instruction may be transmitted to a Bluetooth audio receiving device 102 by a Bluetooth audio source device 101 to initiate transmission of extended broadcast. In another example, the transmission of the extended broadcast may be initiated by the Bluetooth audio receiving device 102 itself, such as a method of a touch key or the like.

At operation S220, broadcast source synchronization information of the BLE audio extension device 103 is configured to the Bluetooth audio receiving device 102 by the BLE audio extension device 103.

In one example, the BLE audio extension device 103 configures the broadcast source synchronization information of the BLE audio extension device 103 to the Bluetooth audio receiving device 102 according to a flow of a BLE broadcast audio scan service.

At operation S230, a broadcast source of the BLE audio extension device 103 is synchronized by the Bluetooth audio receiving device 102 according to the broadcast source synchronization information, and audio data of the broadcast source is received through the broadcast channel.

The audio extension method according to the exemplary embodiment of the present disclosure may shorten a time of scanning the broadcast source and switching the broadcast source by the user while extending the Bluetooth Classic audio to the BLE broadcast audio.

FIG. 5 shows a schematic diagram of switching a Bluetooth audio playing channel to a broadcast channel of a BLE audio extension device 103.

Referring to FIG. 5, after the BLE audio extension device 103 successfully connects to the Bluetooth audio receiving device 102, the BLE audio extension device 103 transmits an audio switching request to the Bluetooth audio source device 101. Upon receiving the request, the Bluetooth audio source device 101 disconnects the Bluetooth Classic connection with the Bluetooth receiving device and switches the Bluetooth audio to the BLE audio extension device 103.

The BLE audio extension device 103 configures the broadcast source synchronization information of the BLE audio extension device 103 to the Bluetooth audio receiving device 102 according to the flow of the BLE broadcast audio scan service, and the Bluetooth audio receiving device 102 synchronizes the broadcast source of the BLE audio extension device 103 according to the broadcast source synchronization information and receives the audio data of the broadcast source.

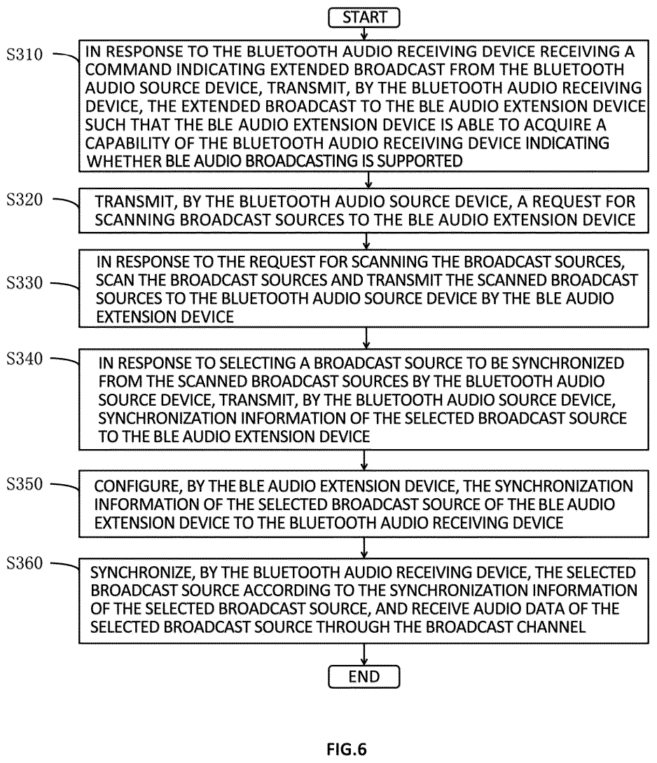

FIG. 6 shows a flowchart of a method of transmitting a BLE audio from a BLE audio extension device 103 to a Bluetooth audio receiving device 102 through BLE connection according to an exemplary embodiment of the present disclosure.

In the exemplary embodiment of FIG. 6, the BLE audio may include audio data of a broadcast source, and the BLE connection may indicate, correspond to, or otherwise include a broadcast channel from the BLE audio extension device 103 to the Bluetooth audio receiving device 102.

Referring to FIG. 6, at operation S310, in response to the Bluetooth audio receiving device 102 receiving a command of extending a broadcast from the Bluetooth audio source device 101, an extended broadcast is transmitted to the BLE audio extension device 103 by the Bluetooth audio receiving device 102 such that the BLE audio extension device 103 is able to acquire a capability of the Bluetooth audio receiving device 102 indicating whether BLE audio broadcasting is supported (e.g., whether the Bluetooth audio receiving device 102 supports BLE audio broadcasting).

The Bluetooth audio receiving device 102 may transmit the extended broadcast, so that the BLE audio extension device 103 may scan and connect the extended broadcast. In one example, an enable extended broadcast instruction may be transmitted to a Bluetooth audio receiving device 102 by a Bluetooth audio source device 101 to initiate transmission of extended broadcast. In another example, the transmission of the extended broadcast may be initiated by the Bluetooth audio receiving device 102 itself, such as a method of a touch key or the like.

At operation S320, a request for scanning broadcast sources is transmitted to the BLE audio extension device 103 by the Bluetooth audio source device 101.

At operation S330, in response to the request for scanning the broadcast sources, the broadcast sources are scanned and the scanned broadcast sources are transmitted to the Bluetooth audio source device 101 by the BLE audio extension device 103.

At operation S340, in response to selecting a broadcast source to be synchronized from the scanned broadcast sources by the Bluetooth audio source device 101, synchronization information of the selected broadcast source is transmitted to the BLE audio extension device 103 by the Bluetooth audio source device 101.

At operation S350, the synchronization information of the selected broadcast source of BLE audio extension device 103 is configured to or for the Bluetooth audio receiving device 102 by the BLE audio extension device 103.

At operation S360, the selected broadcast source is synchronized by the Bluetooth audio receiving device 102 according to the synchronization information of the selected broadcast source, and audio data corresponding to the selected broadcast source is received through the broadcast channel.

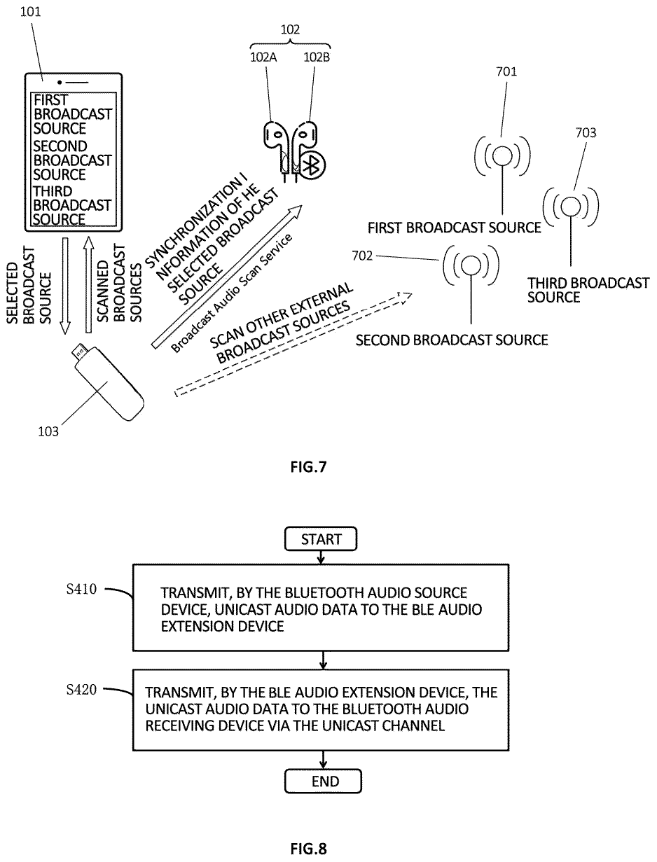

FIG. 7 shows a schematic diagram of a process for scanning and synchronizing other external broadcast sources according to an exemplary embodiment of the present disclosure.

Referring to FIG. 7, broadcast sources scanned by a broadcast assistant (e.g., a first broadcast source 701, a second broadcast source 702, and a third broadcast source 703) are displayed on a display interface of the Bluetooth audio source device 101, and a broadcast source to be synchronized is selected from the scanned broadcast sources by a user or an application on the display interface of the Bluetooth audio source device 101. Thus, the BLE audio extension device 103 according to the exemplary embodiment of the present disclosure may implement a function of the broadcast assistant by using the interface display of the Bluetooth audio source device 101, so that the user may receive data of other external broadcast sources by means of the BLE audio extension device 103, thereby enriching user usage scenarios.

For example, in addition to extending the Bluetooth audio source device 101 from the Bluetooth Classic audio to the BLE broadcast audio, the BLE audio extension device 103 may further implement the function of the broadcast assistant by using the interface display of the Bluetooth audio source device 101. The broadcast assistant may scan other external broadcast source information, and display the broadcast source information to the user. After the user or application selects the broadcast source that needs to be synchronized, the selected broadcast source synchronization information is transmitted to the Bluetooth audio receiving device 102, so that the Bluetooth audio receiving device 102 synchronizes the selected broadcast source and receives audio data transmitted by the broadcast source.

FIG. 8 shows a flowchart of a method of transmitting a BLE audio from a BLE audio extension device 103 to a Bluetooth audio receiving device 102 through BLE connection according to an exemplary embodiment of the present disclosure.

In the exemplary embodiment of FIG. 8, the BLE audio includes unicast audio data, and the BLE connection includes connection indicating a unicast channel from the BLE audio extension device 103 to the Bluetooth audio receiving device 102.

Referring to FIG. 8, at operation S410, the unicast audio data is transmitted to the BLE audio extension device 103 by the Bluetooth audio source device 101.

The Bluetooth audio source device 101 may transmit the unicast audio data to the BLE audio extension device 103 through the connection between the Bluetooth audio source device 101 and the BLE audio extension device 103.

At operation S420, the unicast audio data is transmitted to the Bluetooth audio receiving device 102 by the BLE audio extension device 103 via the unicast channel.

In one embodiment, the BLE connection may be switched between the unicast channel and the broadcast channel. For example, fast automatic switching of the broadcast or unicast audio may be realized by externally connecting the BLE audio extension device 103 to the Bluetooth audio source device 101. For example, the BLE audio extension device 103 may also be referred to as an external BLE audio extension device. The method uses the connection between the Bluetooth audio source device 101 and the external BLE audio extension device to pre-configure the parameters (e.g., an address of an audio receiving device) required by the BLE audio to the external BLE audio extension device, and an audio switching process does not require additional operation of the user and an audio interruption time is relatively short, thereby improving the experience of the user. In addition, the method may use the external BLE audio extension device to receive and transmit a control signaling, such as volume adjustment, multimedia control, etc., thereby enriching the usage scenarios of the user.

The audio extension method according to the exemplary embodiment of the present disclosure may extend the Bluetooth Classic audio to the BLE unicast audio and shorten the switching time while extending the Bluetooth Classic audio to the BLE broadcast audio.

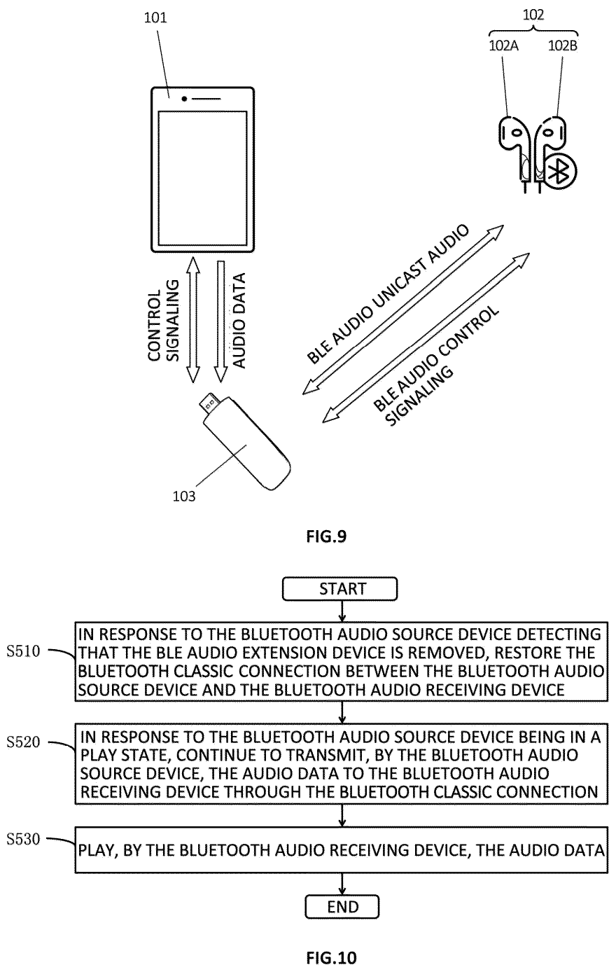

FIG. 9 shows a schematic diagram of switching a Bluetooth audio playing channel to a unicast channel of a BLE audio extension device 103.

Referring to FIG. 9, after the external BLE audio device and the Bluetooth audio receiving device 102 complete the pairing, a notification indicating that establishment of a BLE unicast audio channel is completed is provided to the Bluetooth audio source device 101, and the Bluetooth audio source device 101 disconnects the Bluetooth Classic connection with the Bluetooth audio receiving device 102.

The external BLE audio device starts to establish the BLE unicast audio channel with the Bluetooth audio receiving device 102 according to a flow specified by a BLE audio stream control service. After the BLE audio unicast audio channel is established and completed, the external BLE audio device provides a notification indicating that the establishment of the BLE unicast audio channel is completed to the Bluetooth audio source device 101. After receiving the notification, the Bluetooth audio source device 101 transmits the audio data to the Bluetooth audio receiving device 102 through the external BLE audio unicast.

In addition to the unicast audio channel, the external BLE audio device and the Bluetooth audio receiving device 102 may establish connection of a control service according to their support for BLE audio control signaling, such as multimedia control, call control, volume control, etc. When the Bluetooth audio source device 101 transmits the control signaling to the Bluetooth audio receiving device 102, control information may be converted into a format agreed with the external BLE audio extension device to be transmitted to the BLE audio extension device 103, and finally transmitted to the Bluetooth audio receiving device 102 by the BLE audio extension device 103 through the BLE audio control signaling. However, in some embodiments, the BLE audio extension device 103 may convert the received BLE audio control signaling into a format agreed with the Bluetooth audio source device 101, and then transmit the control information to the Bluetooth audio source device 101.

FIG. 10 shows a flowchart of an audio extension method according to an exemplary embodiment of the present disclosure.

Referring to FIG. 10, at operation S510, in response to the Bluetooth audio source device 101 detecting that the BLE audio extension device 103 is removed (e.g., disconnected from at least one of the Bluetooth audio source device 101 and the Bluetooth audio receiving device 102), the Bluetooth Classic connection between the Bluetooth audio source device 101 and the Bluetooth audio receiving device 102 is restored.

At operation S520, in response to the Bluetooth audio source device 101 being in a play state, the audio data is continuously transmitted to the Bluetooth audio receiving device 102 by the Bluetooth audio source device 101 through the Bluetooth Classic connection.

At operation S530, the audio data is played by the Bluetooth audio receiving device 102.

Accordingly, audio extension method according to the exemplary embodiment of the present disclosure may continue play the audio data to the user through the Bluetooth Classic connection after the BLE audio extension device 103 is removed, thereby improving the user experience.

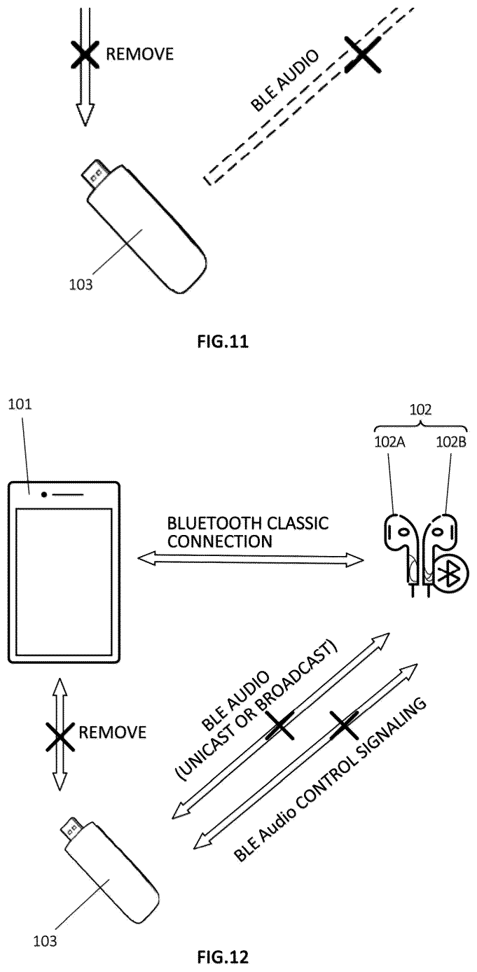

FIGS. 11 and 12 show schematic diagrams of removing a BLE audio extension device 103.

Referring to FIGS. 11 and 12, in response to the Bluetooth audio source device 101 detecting that the BLE audio extension device 103 is removed, the Bluetooth Classic connection between the Bluetooth audio source device 101 and the Bluetooth audio receiving device 102 is restored. In response to the Bluetooth audio source device 101 being in a play state, the audio data is continuously transmitted to the Bluetooth audio receiving device 102 by the Bluetooth audio source device 101 through the Bluetooth Classic connection.

For example, when the Bluetooth audio source device 101 detects that the BLE audio extension device 103 is removed, the Bluetooth audio source device 101 starts to scan and restores the original Bluetooth Classic connection. After the connection is successfully restored, if the current Bluetooth audio source device 101 is still in the play state, the Bluetooth audio source device 101 continues to transmit the audio data to the audio receiving device through the Bluetooth Classic connection.

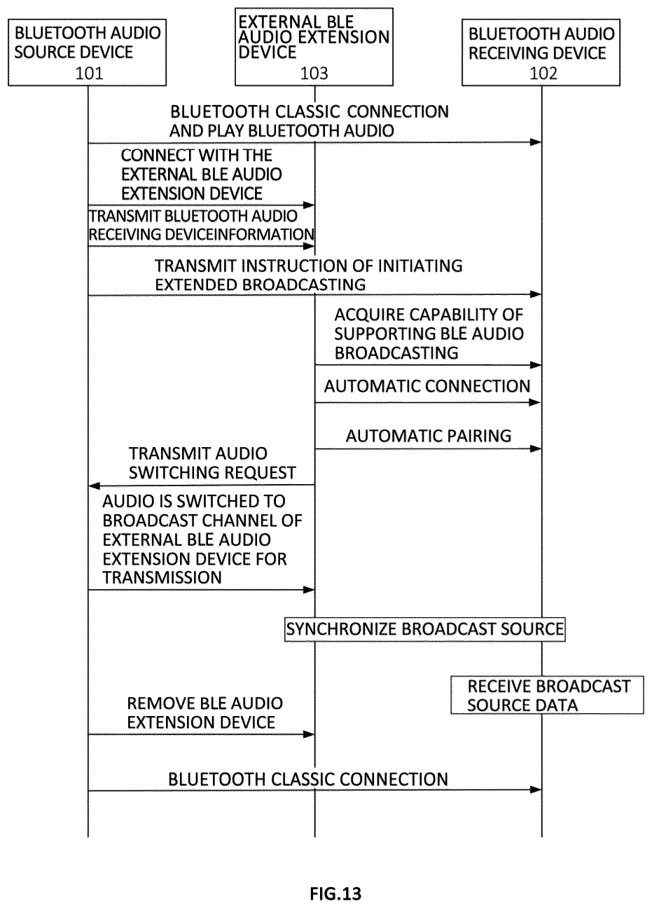

FIG. 13 shows a flowchart of broadcast extension according to an exemplary embodiment of the present disclosure.

Referring to FIG. 13, the Bluetooth audio source device 101 and the Bluetooth audio receiving device 102 may be connected using a Bluetooth Classic connection, and the Bluetooth audio receiving device 102 receives audio data through the Bluetooth Classic and plays the audio data (e.g., the Bluetooth audio).

In response to the Bluetooth audio source device 101 detecting a BLE audio extension device 103, the Bluetooth audio source device 101 transmits the connection information of the Bluetooth audio receiving device 102 (e.g., the Bluetooth audio receiving device information) to the BLE audio extension device 103 through an external device management module.

In response to the Bluetooth audio source device 101 transmitting an instruction of initiating to extend a broadcast to the Bluetooth audio receiving device 102, the Bluetooth audio receiving device 102 may transmit an extended broadcast to the BLE audio extension device 103 such that the BLE audio extension device 103 is able to acquire a capability of the Bluetooth audio receiving device 102 of whether to support BLE audio broadcasting. In one example of the present disclosure, an enable extended broadcast instruction may be transmitted to the Bluetooth audio receiving device 102 by the Bluetooth audio source device 101 to initiate transmission of the extended broadcast. In another example, the transmission of the extended broadcast may also be initiated by the Bluetooth audio receiving device 102 itself, such as a method of a touch key or the like.

The BLE audio extension device 103 automatically scans and automatically pairs with the Bluetooth audio receiving device 102 according to the connection information transmitted by the Bluetooth audio source device 101, and this process does not require user operations.

Hereinafter, the BLE audio extension device 103 may transmit the audio switching request to the Bluetooth audio source device 101.

After the BLE audio extension device 103 successfully connects the Bluetooth audio receiving device 102, the BLE audio extension 103 device transmits the audio switching request to the Bluetooth audio source device 101. Upon receiving the request, the Bluetooth audio source device 101 disconnects the Bluetooth Classic connection with the Bluetooth receiving device and switches the Bluetooth audio to the BLE audio extension device 103 (e.g., switching audio to the broadcast channel of the BLE audio extension device 103 for transmission).

The BLE audio extension device 103 configures the broadcast source synchronization information of the BLE audio extension device 103 to the Bluetooth audio receiving device 102 according to the flow of the BLE broadcast audio scan service, and the Bluetooth audio receiving device 102 synchronizes the broadcast source of the BLE audio extension device 103 according to the broadcast source synchronization information and receives the audio data of the broadcast source.

When the Bluetooth audio source device 101 detects that the BLE audio extension device 103 is removed, it starts to scan and restores the original Bluetooth Classic connection. After the connection is successfully restored, if the current Bluetooth audio source device 101 is still in the play state, the Bluetooth audio source device 101 continues to transmit the audio data to the audio receiving device through the Bluetooth Classic connection.

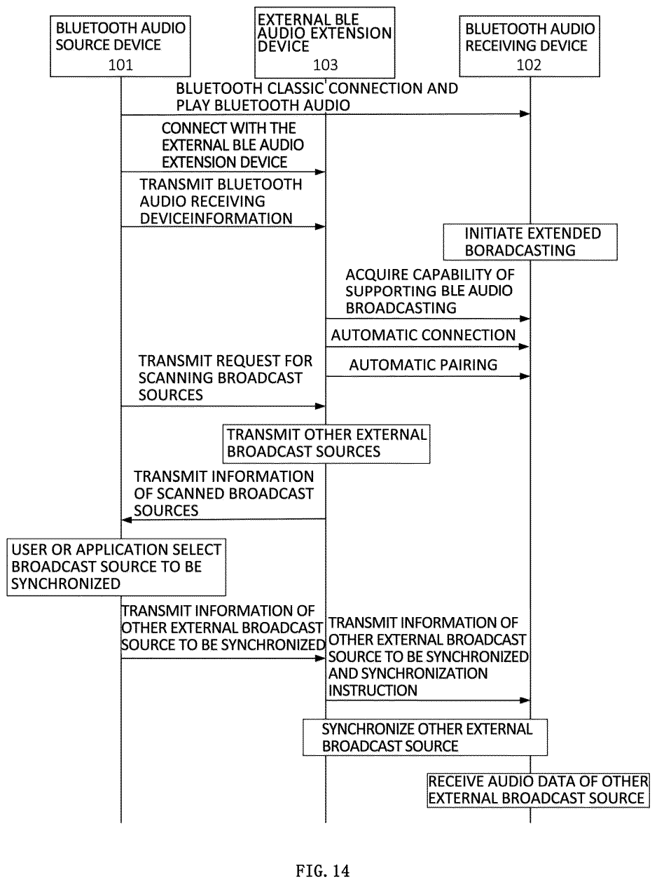

FIG. 14 shows a flowchart of scanning and synchronizing other external broadcast sources according to an exemplary embodiment of the present disclosure.

Referring to FIG. 14, the Bluetooth audio source device 101 and the Bluetooth audio receiving device 102 have Bluetooth Classic connection.

In response to the Bluetooth audio source device 101 detecting a BLE audio extension device 103, the Bluetooth audio source device 101 transmits the connection information of the Bluetooth audio receiving device 102 (e.g., the Bluetooth audio receiving device information) to the BLE audio extension device 103 through an external device management module.

In response to the Bluetooth audio receiving device 102 initiating extended broadcasting, the BLE audio extension device 103 may acquire a support capability of the Bluetooth audio receiving device 102 for the BLE broadcasting.

The BLE audio extension device 103 automatically scans and automatically pairs with the Bluetooth audio receiving device 102 according to the connection information transmitted by the Bluetooth audio source device 101, and this process does not require user operations.

The Bluetooth audio source device 101 may transmit a request for scanning broadcast sources to the BLE audio expansion devices.

In response to the request for scanning the broadcast sources, the BLE audio extension device 103 may scan other external broadcast sources and transmit the scanned broadcast sources to the Bluetooth audio source device 101.

The BLE audio extension device 103 may further implement the function of the broadcast assistant by using the interface display of the Bluetooth audio source device 101. The broadcast assistant may scan other external broadcast source information, and display the broadcast source information to the user, and the user or application may select a broadcast source that needs to be synchronized. The Bluetooth audio source device 101 transmits other external broadcast source information to be synchronized to the BLE audio extension device 103, and the BLE audio extension device 103 may transmit other external broadcast source information to be synchronized and a synchronization command to the Bluetooth audio receiving device 102. The Bluetooth audio receiving device 102 and the BLE audio extension device 103 synchronize other external broadcast sources and receive the audio data transmitted by other external broadcast sources.

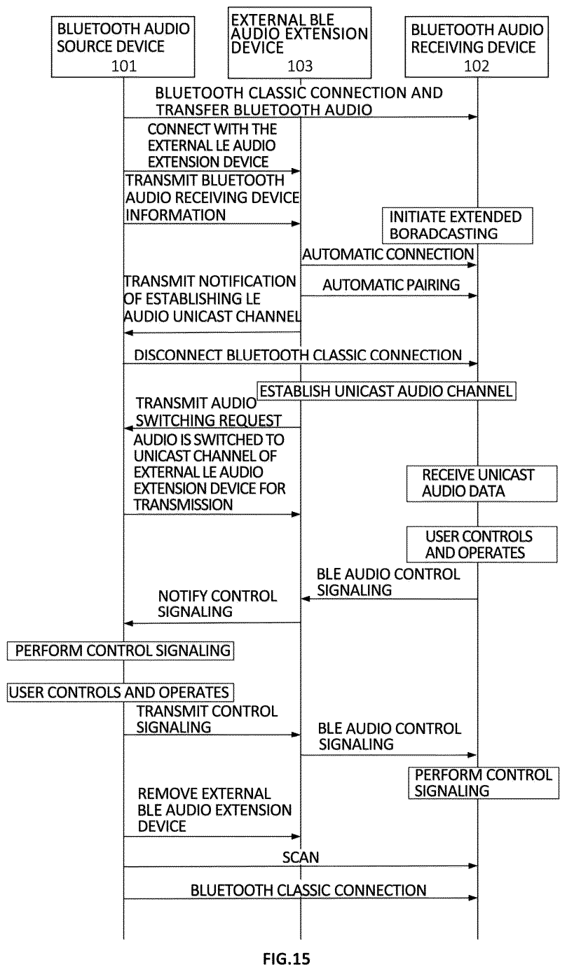

FIG. 15 shows a flowchart of unicast extension according to an exemplary embodiment of the present disclosure.

The Bluetooth audio source device 101 and the Bluetooth audio receiving device 102 may be connected through Bluetooth Classic and the Bluetooth audio source device 101 is playing an audio, and the Bluetooth audio receiving device 102 receives the audio data through the Bluetooth Classic.

If the Bluetooth audio source device 101 detects a BLE audio extension device 103, the Bluetooth audio source device 101 transmits the connection information of the Bluetooth audio receiving device 102 to the BLE audio extension device 103 through the external device management module.

The Bluetooth audio receiving device 102 transmits the extended broadcast, so that the BLE audio extension device 103 may scan and connect. According to embodiments, an enable extended broadcast instruction may be transmitted to the Bluetooth audio receiving device 102 by the Bluetooth audio source device 101 to initiate transmission of the extended broadcast, and the transmission for the extended broadcast may also be initiated by the Bluetooth audio receiving device 102 itself, such as a means of a touch key, or the like.

The BLE audio extension device 103 automatically scans and automatically connects the Bluetooth audio receiving device 102 according to the connection information transmitted by the Bluetooth audio source device 101.

The BLE audio extension device 103 scans connectable extension broadcast according to the connection information transmitted by the Bluetooth audio source device 101, and initiates BLE Bluetooth connection after identifying the Bluetooth audio receiving device 102 to be connected. In a Bluetooth pairing stage, the Bluetooth audio receiving device 102 and the external BLE audio device have configured prior information such as the device address, the device name, etc. through the Bluetooth audio source device 101. In the pairing stage, a pairing process is completed directly without user intervention.

After the external BLE audio device and the Bluetooth audio receiving device 102 complete the pairing, a notification indicating that a BLE unicast audio channel is completed is provided to the Bluetooth audio source device 101, and the Bluetooth audio source device 101 disconnects the Bluetooth Classic connection with the Bluetooth audio receiving device 102.

The external BLE audio device starts to establish the BLE unicast audio channel with the Bluetooth audio receiving device 102 according to a flow specified by a BLE audio stream control service. After the BLE unicast audio channel is established and completed, the external BLE audio device notifies the result that the establishment of the BLE unicast audio channel is completed to the Bluetooth audio source device 101. After receiving the result, the Bluetooth audio source device 101 transmits the audio data to the Bluetooth audio receiving device 102 through the external BLE audio device unicast.

In addition to the unicast audio channel, the external BLE audio device and the Bluetooth audio receiving device 102 may establish connection of a control service according to their support for BLE audio control signaling, such as multimedia control, call control, volume control, etc. When the Bluetooth audio source device 101 transmits the control signaling to the Bluetooth audio receiving device 102, control information may be converted into a format agreed with the external BLE audio extension device to be transmitted to the BLE audio extension device 103, and finally transmitted to the Bluetooth audio receiving device 102 by the BLE audio extension device 103 through the BLE audio control signaling. However, in some embodiments, the BLE audio extension device 103 may convert the received BLE audio control signaling into a format agreed with the Bluetooth audio source device 101, and then transmit the control information to the Bluetooth audio source device 101.

When the Bluetooth audio source device 101 detects that the BLE audio extension device 103 is removed, it starts to scan and restores the original Bluetooth Classic connection. After the connection is successfully restored, if the current Bluetooth audio source device 101 is still in the play state, the Bluetooth audio source device 101 will continue to transmit the audio data to the audio receiving device through the Bluetooth Classic connection.

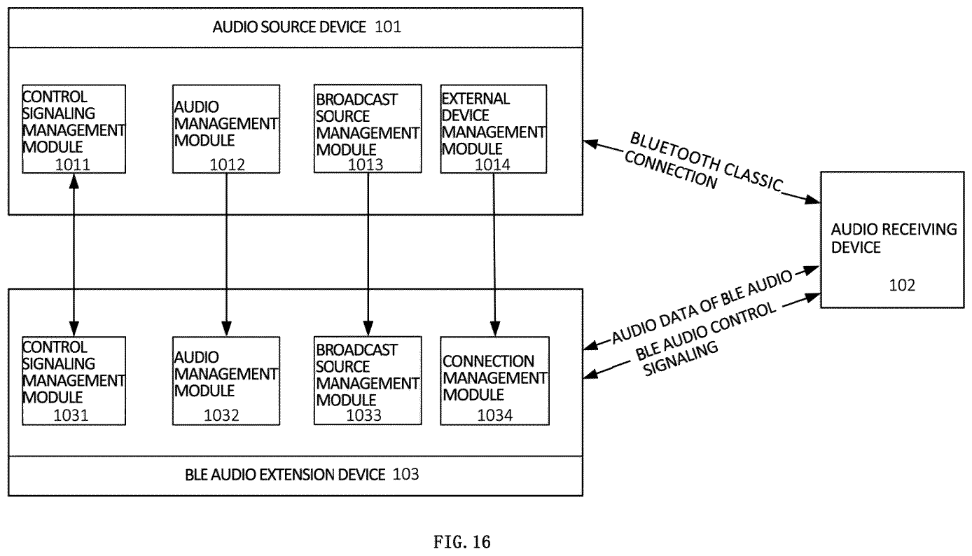

FIG. 16 shows a schematic diagram of an audio extension system according to an exemplary embodiment of the present disclosure.

Referring to FIG. 16, an audio extension system may include a Bluetooth audio source device 101, a BLE audio extension device 103 and an audio receiving device.

The Bluetooth audio source device 101, the BLE audio extension device 103 and the audio receiving device may perform one or more operations as described with reference to FIG. 1 to FIG. 15. For example, in response to detecting a BLE audio extension device 103, the Bluetooth audio source device 101 may transmit connection information of a Bluetooth audio receiving device 102 to the BLE audio extension device 103, wherein the Bluetooth audio source device may support Bluetooth Classic; The BLE audio extension device 103 may perform BLE connection between the BLE audio extension device 103 and the Bluetooth audio receiving device 102 according to the connection information, and transmit a BLE audio received from the Bluetooth audio source device 101 to the Bluetooth audio receiving device 102 using the BLE connection; The Bluetooth audio receiving device 102 may play the BLE audio.

In one example, the BLE audio extension device 103 may include at least one processor and at least one memory storing computer executable instructions. The computer executable instructions, when executed by the at least one processor, cause the at least one processor to execute following operations: receiving, from a Bluetooth audio source device 101, connection information of a Bluetooth audio receiving device 102 transmitted in response to the Bluetooth audio source device 101 detecting a BLE audio extension device 103, wherein the Bluetooth audio source device 101 is configured to support Bluetooth Classic; performing or establishing BLE connection between the BLE audio extension device 103 and the Bluetooth audio receiving device 102 according to the connection information; and transmitting, by the BLE audio extension device 103, a BLE audio received from the Bluetooth audio source device 101 to the Bluetooth audio receiving device 102 using the BLE connection, wherein the Bluetooth audio receiving device 102 is configured to play the BLE audio (e.g., audio corresponding to BLE audio data).

In one exemplary embodiment, the Bluetooth audio source device 101 includes a control signaling management module 1011, an audio management module 1012, a broadcast source management module 1013 and an external device management module 1014. The control signaling management module 1011 is responsible for receiving and transmitting the control information of the Bluetooth audio source device 101, and transmitting the control information to the BLE audio extension device 103 in a format agreed with the BLE audio extension device 103. In addition, it is responsible for receiving and parsing BLE audio control information transmitted by a BLE audio control module, and transmitting the control information to the Bluetooth audio source device 101. The audio management module 1012 decides whether to switch audio data to the BLE audio extension device 103 for transmission according to a notification of the BLE audio extension device 103. The external device management module 1014 may detect whether an external BLE audio device is connected or removed, and perform extension from the Bluetooth Classic audio to the BLE audio according to a state of connection or removal and an audio playing state of the Bluetooth audio source device 101. A broadcast source management module 1013 is responsible for controlling the BLE audio extension device 103 to scan broadcast sources, receiving and displaying scanned broadcast source information transmitted by the BLE audio extension device 103, and transmitting broadcast source information selected by an application or user to the BLE audio extension device 103.

In one exemplary embodiment, the BLE audio extension device 103 includes a control signaling management module1031, an audio management module 1032, broadcast source management module 1033, and a connection management module 1034. The control signaling management module 1031 is responsible for converting received BLE audio control signaling into a format agreed with the Bluetooth audio source device 101, and then transmitting the control information to the Bluetooth audio source device 101. In addition, it is responsible for receiving control information transmitted by the Bluetooth audio source device 101, and transmitting the control information to the Bluetooth audio receiving device 102 according to a format of the BLE audio control signaling. The audio management module 1032 decides whether to transmit an audio switching request to the Bluetooth audio source device 101 according to a requirement of establishing a BLE audio channel, and transmits the BLE audio out through the BLE audio channel after the audio switching. A connection management module 1034 receives the connection information transmitted by the Bluetooth audio source device 101, and processes the BLE Bluetooth connection between the BLE audio extension device 103 and the Bluetooth audio receiving device 102 according to the connection information. A broadcast source management module 1033 is responsible for receiving a broadcast scanning or stopping instruction of the Bluetooth audio source device 101, starting or stopping to scan other external broadcast sources, and transferring the scanned broadcast sources to the Bluetooth audio source device 101 to facilitate the user to select a broadcast source to be synchronized. After the broadcast source synchronization information transmitted by the Bluetooth audio source device 101 is received, the broadcast source synchronization information is transmitted to the Bluetooth audio receiving device 102 through the BLE audio broadcast audio scan service such that the external Bluetooth audio receiving device 102 may synchronize other external broadcast source.

In addition, it should be understood that the individual units in an apparatus according to an exemplary embodiment of the present disclosure may be implemented as hardware components and/or software components. According to the processes executed by each defined unit, those skilled in the art can use a field-programmable gate array (FPGA) or an application-specific integrated circuit (ASIC) to implement each unit.

Although the present disclosure includes specific examples, it will be apparent to those skilled in the art that various changes in form and detail may be made in these examples without departing from the spirit and scope of the claims and their equivalents. The examples described herein should be considered descriptive only and not for the purpose of limitation. The description of a feature or aspect in each example shall be considered applicable to similar features or aspects in other examples. A suitable result may be achieved if the described techniques are performed in a different order, and/or if the components of the described system, architecture, device or circuit are combined in a different manner, and/or replaced or supplemented by other components or their equivalents. Accordingly, the scope of disclosure is not limited by the detailed description, but by the claims and their equivalents, and all changes within the scope of the claims and their equivalents shall be construed to include the disclosure.

What is claimed is:

1. An audio extension method, comprising:
based on an audio extension device being detected by an audio source device, receiving, by the audio extension device, connection information associated with an audio receiving device from the audio source device, wherein the audio source device is configured to support a Bluetooth Classic protocol;
establishing, by the audio extension device, a Bluetooth Low Energy (BLE) connection according to a BLE protocol between the audio extension device and the audio receiving device according to the connection information; and
transmitting, by the audio extension device, audio data received from the audio source device to the audio receiving device using the BLE connection,
wherein audio corresponding to the audio data is played by the audio receiving device.

2. The audio extension method of claim 1, wherein the audio data is associated with a broadcast source, and the BLE connection comprises a broadcast channel from the audio extension device to the audio receiving device, and
wherein the transmitting of the audio data comprises:
based on the audio receiving device receiving a command indicating an extended broadcast from the audio source device, receiving, by the audio extension device, the extended broadcast from the audio receiving device;
acquiring, by the audio extension device, a capability of the audio receiving device that indicates whether BLE audio broadcasting is supported; and
configuring, by the audio extension device, broadcast source synchronization information of the audio extension device to the audio receiving device, and
wherein the broadcast source is synchronized by the audio receiving device according to the broadcast source synchronization information to receive the audio data corresponding to the broadcast source through the broadcast channel.

3. The audio extension method of claim 1, wherein the audio data is associated with a broadcast source, and the BLE connection corresponds to a broadcast channel from the audio extension device to the audio receiving device, and
wherein the transmitting of the audio data comprises:
based on the audio receiving device receiving a command indicating extended broadcast from the audio source device, receiving, by the audio extension device, the extended broadcast from the audio receiving device;
acquiring, by the audio extension device, a capability of the audio receiving device that indicates whether BLE audio broadcasting is supported;
receiving, by the audio extension device, a request for scanning a plurality of broadcast sources from the audio source device;
based on the request for scanning the plurality of broadcast sources, scanning the plurality of broadcast sources and transmitting, by the audio extension device, the scanned plurality of broadcast sources to the audio source device;
based on the broadcast source being selected from among the scanned plurality of broadcast sources, receiving, by the audio extension device, synchronization information associated with the broadcast source from the audio source device; and
configuring, by the audio extension device, the synchronization information corresponding to the selected broadcast source,
wherein the broadcast source is synchronized by the audio receiving device according to the synchronization information, and the audio data corresponding to the broadcast source is received by the audio receiving device through the broadcast channel.

4. The audio extension method of claim 3, wherein the scanned plurality of broadcast sources are scanned by a broadcast assistant and displayed on a display interface included in the audio source device.

5. The audio extension method of claim 1, wherein the audio data comprises unicast audio data, and the BLE connection corresponds to a unicast channel from the audio extension device to the audio receiving device, and
wherein the transmitting of the audio data by the audio extension device comprises:
receiving, by the audio extension device, the unicast audio data from the audio source device; and
transmitting, by the audio extension device, the unicast audio data to the audio receiving device using the unicast channel.

6. The audio extension method of claim 1, wherein the connection information comprises at least one parameter used to establish the BLE connection between the audio extension device and the audio receiving device, and
wherein the at least one parameter comprises a device address and a device name.

7. The audio extension method of claim 1, wherein the receiving of the connection information comprises:
based on the audio source device detecting that the audio extension device and the audio receiving device are playing the audio data received from the audio source device using the Bluetooth Classic protocol, receiving, by the audio extension device, the connection information from the audio source device, and
wherein a Bluetooth Classic connection between the audio source device and the audio receiving device is disconnected after the BLE connection between the audio extension device and the audio receiving device is established.

8. The audio extension method of claim 7, wherein the audio extension method further comprises:
based on the audio source device detecting that the audio extension device is disconnected, restoring the Bluetooth Classic connection between the audio source device and the audio receiving device, and
wherein based on the audio source device being in a play state, the audio data is transmitted to the audio receiving device using the Bluetooth Classic connection, and the audio corresponding to the audio data is played by the audio receiving device.

9. An audio extension system, comprising:
an audio source device configured to, based on detecting an audio extension device, transmit connection information associated with an audio receiving device to the audio extension device, wherein the audio source device is configured to support a Bluetooth Classic protocol;
the audio extension device, wherein the audio extension device is configured to establish a Bluetooth Low Energy (BLE) connection according to a BLE protocol between the audio extension device and the audio receiving device based on the connection information, and transmit audio data received from the audio source device to the audio receiving device using the BLE connection; and
the audio receiving device, wherein the audio receiving device is configured to play audio associated with the audio data.

10. The audio extension system of claim 9, wherein the audio data corresponds to a broadcast source, and the BLE connection comprises a broadcast channel from the audio extension device to the audio receiving device, and
wherein the audio receiving device is further configured to, based on receiving a command indicating extended broadcast from the audio source device, transmit the extended broadcast to the audio extension device,
wherein the audio extension device is further configured to:
based on receiving the extended broadcast, acquire a capability of the audio receiving device indicating whether BLE audio broadcasting is supported; and
configure broadcast source synchronization information of the BLE audio extension device to the audio receiving device, and
wherein the audio receiving device is further configured to:
synchronize the broadcast source according to the broadcast source synchronization information; and
receive the audio data corresponding to the broadcast source through the broadcast channel.

11. The audio extension system of claim 9, wherein the audio data corresponds to a broadcast source, and the BLE connection corresponds to a broadcast channel from the audio extension device to the audio receiving device,
wherein the audio receiving device is further configured to, based on receiving a command indicating an extended broadcast from the audio source device, transmit the extended broadcast to the audio extension device,
wherein the audio extension device is further configured to, based on receiving the extended broadcast, acquire a capability of the audio receiving device indicating whether BLE audio broadcasting is supported;
wherein the audio source device is further configured to transmit a request for scanning a plurality of broadcast sources to the audio extension device,
wherein the audio extension device is further configured to:
based on receiving the request for scanning the plurality of broadcast sources, scan the plurality of broadcast sources; and
transmit the scanned plurality of broadcast sources to the audio source device;
wherein the audio source device is further configured to, based on the broadcast source being selected from among the scanned plurality of broadcast sources, transmit synchronization information associated with the broadcast source to the audio extension device,
wherein the audio extension device is further configured to configure the synchronization information of the selected broadcast source of the BLE audio extension device to the audio receiving device, and
wherein the audio receiving device is further configured to:
synchronize the selected broadcast source according to the synchronization information associated with the broadcast source; and
receive the audio data corresponding to the broadcast source through the broadcast channel.

12. The audio extension system of claim 11, wherein the audio source device is further configured to:
display the scanned plurality of broadcast sources that are scanned by a broadcast assistant on a display interface included in the audio source device; and
based on an input received from at least one of a user and an application, select the broadcast source from among the scanned plurality of broadcast sources.

13. The audio extension system of claim 9, wherein the audio data comprises unicast audio data, and the BLE connection comprises a unicast channel from the audio extension device to the audio receiving device,
wherein the audio source device is further configured to transmit the unicast audio data to the audio extension device, and
wherein the audio extension device is further configured to transmit the unicast audio data to the audio receiving device using the unicast channel.

14. The audio extension system of claim 9, wherein the connection information comprises at least one parameter used to establish the BLE connection between the audio extension device and the audio receiving device, and
wherein the at least one parameter comprises a device address and a device name.

15. The audio extension system of claim 9, wherein the audio source device is further configured to, based on detecting the audio extension device and the audio receiving device being playing of the audio corresponding to the audio data received from the audio source device using the Bluetooth Classic protocol, transmit the connection information to the audio extension device, and
wherein a Bluetooth Classic connection between the audio source device and the audio receiving device is disconnected after the BLE connection is established between the audio extension device and the audio receiving device.

16. The audio extension system of claim 15,
wherein the audio source device is further configured to:
based on determining that the audio extension device is disconnected, restore the Bluetooth Classic connection between the audio source device and the audio receiving device; and
based on the audio source device being in a play state, transmit the audio data to the audio receiving device using the Bluetooth Classic connection, and
wherein the audio receiving device is further configured to play the audio corresponding to the audio data.

17. An audio extension device, comprising:
at least one processor;
at least one memory configured to store computer executable instructions,
wherein the computer executable instructions, when executed by the at least one processor, cause the audio extension device to:
receive, from an audio source device, connection information associated with an audio receiving device based on the audio source device detecting the audio extension device, wherein the audio source device is configured to support a Bluetooth Classic protocol;
establish a Bluetooth Low Energy (BLE) connection according to a BLE protocol between the audio extension device and the audio receiving device based on the connection information; and
transmit audio data received from the audio source device to the audio receiving device using the BLE connection, wherein the audio receiving device is configured to play audio corresponding to the audio data.

18. The audio extension device of claim 17,
wherein the audio data is associated with a broadcast source, and the BLE connection comprises a broadcast channel from the audio extension device to the audio receiving device, and
wherein the transmitting of the audio data comprises:
based on the audio receiving device receiving a command indicating an extended broadcast from the audio source device, receiving, by the audio extension device, the extended broadcast from the audio receiving device;
acquiring, by the audio extension device, a capability of the audio receiving device that indicates whether BLE audio broadcasting is supported; and
configuring, by the audio extension device, broadcast source synchronization information of the audio extension device to the audio receiving device, and
wherein the broadcast source is synchronized by the audio receiving device according to the broadcast source synchronization information to receive the audio data corresponding to the broadcast source through the broadcast channel.

19. The audio extension device of claim 17, wherein the audio data is associated with a broadcast source, and the BLE connection corresponds to a broadcast channel from the audio extension device to the audio receiving device, and
wherein the transmitting of the audio data comprises:
based on the audio receiving device receiving a command indicating extended broadcast from the audio source device, receiving, by the audio extension device, the extended broadcast from the audio receiving device;
acquiring, by the audio extension device, a capability of the audio receiving device that indicates whether BLE audio broadcasting is supported;
receiving, by the audio extension device, a request for scanning a plurality of broadcast sources from the audio source device;
based on the request for scanning the plurality of broadcast sources, scanning the plurality of broadcast sources and transmitting, by the audio extension device, the scanned plurality of broadcast sources to the audio source device;
based on the broadcast source being selected from among the scanned plurality of broadcast sources, receiving, by the audio extension device, synchronization information associated with the broadcast source from the audio source device; and
configuring, by the audio extension device, the synchronization information corresponding to the selected broadcast source,
wherein the broadcast source is synchronized by the audio receiving device according to the synchronization information, and the audio data corresponding to the broadcast source is received by the audio receiving device through the broadcast channel.

20. The audio extension device of claim 19, wherein the scanned plurality of broadcast sources are scanned by a broadcast assistant and displayed on a display interface included in the audio source device.
